(19) United States
(12) Patent Application Publication
(10) Pub. No.: US 2008/0030142 A1
(43) Pub. Date: Feb. 7, 2008

(54) Power regenerating apparatus

(75) Inventors: Satoru Jinno, Tokyo (JP); Isao Shindo, Tokyo (JP); Mitsuhiro Kosaka, Tokyo (JP); Masashi Shinohara, Tokyo (JP); Hiroshi Ito, Tokyo (JP)

Correspondence Address: NIXON & VANDERHYE, PC, 901 NORTH GLEBE ROAD, 11TH FLOOR, ARLINGTON, VA, 22203, US

(73) Assignee: Pioneer Corporation, Tokyo (JP)

(21) Appl. No.: 11/882,375

(22) Filed: Aug. 1, 2007

(30) Foreign Application Priority Data
Aug. 7, 2006 (JP) 2006-214873

(51) Int. Cl. H05B 39/00; G09G 3/28

(52) U.S. Cl. 315/169.4

(57) ABSTRACT

A plasma display apparatus (10) is provided with: a control device 100; a PDP 900 including a display panel device 200 and a driving device 400; and a functional device 500. In operation of the PDP 900, an X driving device 420 and a Y driving device 430 of the driving device 400 are drive-controlled by the control device 100, and sustain pulse voltages are applied to sustain electrodes 213 of the display panel device 200. This generates unnecessary radiant electromagnetic wave near the display panel device 200 and the driving device 400. A coil 610 of a power regenerating apparatus 600 is provided such that the core direction of an air core portion 611b is perpendicular to the radiant direction of the unnecessary radiant electromagnetic wave, and the coil converts the unnecessary radiant electromagnetic wave to an AC voltage. The AC voltage is converted to a DC voltage by a rectifying device 620 and it is regenerated as DC power for the functional device 500 through a power supply line.

### BACKGROUND OF THE INVENTION

1. Field of the Invention

The present invention relates to a power regenerating apparatus which allows regeneration of electric power.

2. Background Art

A display apparatus which uses a plasma display panel (hereinafter referred to as a “PDP”, as occasion demands) has been proposed (e.g. refer to Japanese Patent Application Laid Open NO. Hei 9-275534). According to the display apparatus disclosed in the above-mentioned patent document (hereinafter referred to as a “conventional technology”), it is possible to prevent the temperature of the PDP itself from increasing by disposing a plate-like functional filter, which is to shield electromagnetic wave, in front of the front glass of the PDP, with a gap for air flow.

In the conventional technology, the electromagnetic wave shielding filter can shield electromagnetic wave generated in the operation of the PDP and can prevent the electromagnetic wave from leaking to the vicinity of the PDP. The radiant electromagnetic wave, however, is energy resource which can be used as electric power energy, and the shielding may waste the energy resource. That is, the conventional technology has such a technical problem that it is hard to operate the PDP while effectively using the energy resource. Incidentally, such a problem can also occur not only in the PDP but also in equipment which causes unnecessary radiation of electromagnetic wave in its operation.

### SUMMARY OF THE INVENTION

It is therefore an object of the present invention to provide a power regenerating apparatus which allows efficient use of energy resource in this type of equipment or the like.

(A Power Regenerating Apparatus)

The above object of the present invention can be achieved by a power regenerating apparatus provided with: a converting device, which is disposed in a set position in which the converting device is in contact with electromagnetic wave related to unnecessary radiation of target equipment with the unnecessary radiation of the electromagnetic wave in operation and which converts the electromagnetic wave related to the unnecessary radiation to a voltage corresponding to the electromagnetic wave related to the unnecessary radiation; and a regenerating device for regenerating electric power corresponding to the converted voltage for at least one portion of the target equipment corresponding.

In the power regenerating apparatus of the present invention, the “target equipment” includes equipment with the unnecessary radiation of the electromagnetic wave in operation. The unnecessary radiation of the electromagnetic wave includes the radiation of electromagnetic wave generated secondarily in a space in the vicinity of the target equipment along with the main operation of the target equipment, the radiation of electromagnetic wave which does not directly contribute to the extent of an effect obtained by the main operation, and the like.

As long as it operates with the unnecessary radiation of the electromagnetic wave, the target equipment has no limitation on physical, mechanical, mechanistic, or electrical structure. Generally, however, the unnecessary radiation is mostly generated in a form of electric wave (strictly speaking, electric wave with frequencies of 30 Hz to 3 THz) out of the electromagnetic wave. From such a viewpoint, preferably, the target equipment indicates equipment with the unnecessary radiation of electric wave.

Here, particularly, the electromagnetic wave related to the unnecessary radiation (hereinafter referred to as the “unnecessary radiant electromagnetic wave”, as occasion demands) is generated secondarily along with the operation of the target equipment, as described above. The unnecessary radiant electromagnetic wave radiates in the surrounding space of the target equipment as it is, or it is shielded by a shielding device, such as a shield and a cover, made of a metal material or the like not to have some adverse influence, which is defined quantitatively or qualitatively, on the target equipment or various equipment, apparatus, system, human body, or the like, which are located in the vicinity of the target equipment. The unnecessary radiant electromagnetic wave can be also used as energy resource as long as it is electromagnetic wave. In this case, it is hard to say that energy resource is efficiently used. Thus, the efficient use of energy resource is enhanced as follows in the power regenerating apparatus.

That is, according to the power regenerating apparatus of the present invention, in its operation, the unnecessary radiant electromagnetic wave is converted to the voltage corresponding thereto by the converting device which can employ a form of coil or loop antenna or a similar form, which can include a conductive material, such as a metal material.

Here, the converting device is disposed in the set position defined such that the converting device is in contact with the unnecessary radiant electromagnetic wave of the target equipment. In other words, the converting device is adapted to convert the unnecessary radiant electromagnetic wave to a voltage along with the physical, electrical, or magnetic contact with the unnecessary radiant electromagnetic wave. For example, if the unnecessary radiant electromagnetic wave has a form of electric wave, as described above, the above-mentioned coil or similar form is preferable as the converting device. In this case, the unnecessary radiant electromagnetic wave is converted to an alternating current (AC) voltage by the action of electromagnetic induction caused by a time change in an electromagnetic field due to the unnecessary radiant electromagnetic wave.

Incidentally, although the converting device can preferably employ such a form of coil or the like, of course, its physical, mechanical, mechanistic, or electrical structure may be arbitrary depending on the type, characteristics, or the like of the unnecessary radiant electromagnetic wave as long as the unnecessary radiant electromagnetic wave can be converted to the voltage corresponding thereto. For example, if the unnecessary radiant electromagnetic wave employs a form of light, the at least one portion may include a photoelectric conversion element, such as a solar cell and a photo diode.

Meanwhile, if the unnecessary radiant electromagnetic wave is converted to the voltage by the converting device, the electric power corresponding to the voltage is regenerated for at least one portion of the target equipment.

Here, the “regeneration” in the present invention is a concept including that the voltage converted by the converting device is returned as the driving force of the entire target equipment or at least its partial driving force in the form of electric power corresponding to the voltage, regardless of the difference of direct current (DC) and alternating current (AC). As long as the concept is ensured, there is no limitation on the structure of the regenerating device, particularly, its mechanical, mechanistic, physical, or electrical structure. For example, it may have a structure to supply electric power to a power supply system of the target equipment connected to a commercial power supply, or it may have a structure to charge a chargeable battery properly which can function as at least one portion of the power supply of the target equipment. Alternatively, it may have a structure to supply electric power directly to one portion of the target equipment, which is, for example, various cooling devices, such as a cooling fun, for cooling the target equipment, an announcing device, such as an indicator, for visually announcing the operational state or functional state of the target equipment, a light receiving device for receiving an infrared command signal or the like, which is transmitted from a remote control apparatus or the like for remotely controlling the target equipment, and the like.

Therefore, the regenerating device is provided with a part, member, circuit, mechanism, apparatus, functional unit, system, or the like, which are to generate a current corresponding to the voltage obtained by the converting device. For example, as one simplest form, the regenerating device can employ a form including various cables, such as an electric cable, a transmission line, or a connecter accompanied by those, and a load resistance further added to those. Alternatively, the regenerating device may be unified with the target equipment as one portion of the target equipment. In this case, the regenerating device may have a form of assembly in which functional parts related to the regenerating device are mounted on a substrate or the like in advance.

Incidentally, if the AC voltage is obtained as a result of the electromagnetic induction on the coil or the like, as described above, and the operating voltage of the target equipment is a DC voltage, electric power cannot be regenerated effectively as it is. In this case, the regenerating device includes a rectifying device (which may include a smoothing device for smoothing DC ripple) including a diode, a resistance, a condenser, and the like, as occasion demands, and the regenerating device may be adapted to convert the AC voltage to the DC voltage. Moreover, if absolute voltage is insufficient in the DC voltage obtained by the rectifying device, the regenerating device may be further provided with a boosting device, such as a DC-DC converter. Moreover, the regenerating device may include a transforming device, such as a transformer, and a DC-AC converting device (which may function as a transforming device), such as an inverter.

As described above, according to the present invention, the unnecessary radiant electromagnetic wave, which can be generated inevitably and secondarily by operation the target equipment, is first converted to the voltage, and it is eventually returned to the target equipment as the form of electric power based on the voltage. In other words, it is regenerated. To put it more simply, the driving force for driving at least one portion of the target equipment can be obtained as a result of operating the target equipment. That is, energy resource can be efficiently used.

Incidentally, the power regenerating apparatus of the present invention may be unified with the target equipment of the present invention or may be at least partially detachable to the target equipment.

In one aspect of the power regenerating apparatus of the present invention, the target equipment includes a plasma display panel.

The plasma display panel (PDP) is a panel for display, which is preferably used for a plasma display apparatus, a plasma television apparatus, and the like. For example, the PDP includes a panel device for display, a driving device for driving the panel device. During a main operation (e.g. an operation of displaying video images), plasma discharge is generated in each discharge cell, so that the unnecessary radiation of electric wave, which is one type of the electromagnetic wave, tends to be generated, and the amount and area of radiation also tend to be relatively large. Therefore, it is possible to easily obtain the voltage, to the extent that the regeneration of electric power based on the unnecessary radiant electromagnetic wave is remarkably effective, by the converting operation of the converting device. It is also preferable as the target equipment of the present invention.

Incidentally, in this aspect, the set position may include a position corresponding to a sustain electrode of the plasma display panel.

For example, the panel device for display of the PDP can employ such a structure that a sustain electrode (or referred to as a row electrode) and an address electrode (or referred to as a data electrode or a column electrode) are provided respectively for one pair of a front panel and a rear panel, which face each other through a space separated by a bulkhead. In this case, the sustain electrode and the address electrode extend perpendicularly in planar vision, and a space corresponding to the intersection of these electrodes in the above-mentioned space often makes one cell of the PDP. Moreover, the space separated by the bulkhead encloses a predetermined gas, such as Ar, Xe, and Ne. Moreover, a fluorescent material corresponding to each color of RGB is applied to the internal surface of the bulkhead.

In this type of PDP, plasma discharge is continuously generated by a sustain voltage, such as a sustain pulse voltage (which is not necessarily limited to a form of pulse voltage and which may be a rectangular voltage depending on the structure of a power supply circuit or the like), which is applied to the sustain electrode in a predetermined sustain discharge period, in the cell selected in a predetermined address period (more specifically, a cell in which wall charges formed in a reset discharge period are not eliminated by address discharge in the address period, or a cell in which the wall charges eliminated in the reset discharge period are reformed by the address discharge, or the like). At this time, the fluorescent material in each cell is excited by ultraviolet rays generated with the plasma discharge, and each cell emits light in an emission color corresponding to the applied fluorescent material.

Here, the sustain voltage applied in the sustain discharge period is a high voltage of approximately several hundred volts, and it has a short pulse frequency of the sustain voltage or short application cycle of the sustain voltage (i.e. it belongs to a group of high frequency). Thus, the unnecessary radiant electromagnetic wave tends to be generated significantly in the sustain discharge period. Therefore, the unnecessary radiant electromagnetic wave can be converted to a voltage efficiently and effectively by setting the set position of a converting device to the position corresponding to the sustain electrode.

Incidentally, the “position corresponding to the sustain electrode” includes the surrounding space of the sustain electrode and includes a circuit, unit, mechanism, apparatus, system, or the like in the vicinity of the sustain electrode, which have some correspondence relationship with the application of a high voltage by the sustain electrode. In particular, this time, it is experimentally clear by the applicants that the amount of radiation related to the unnecessary radiant electromagnetic wave is significantly large in a driving system or the like which constitutes the PDP with the panel device for display and which includes a power supply, switching element, power supply path, or the like, for driving the sustain electrode. The position corresponding to the sustain electrode is significantly effective by setting it in the vicinity of the driving system.

In another aspect of the power regenerating apparatus of the present invention, the converting device includes a coil in which a conductive wire material is wound on a core portion.

According to this aspect, the converting device is constructed as the coil in which the conductive wire material, which can employ a form of metal wire, such as a copper wire, enameled wire obtained by the insulating coating of the metal wire, or the like, is wound on the core portion, such as an air core (i.e. a cavity) and an iron core. At this time, the unnecessary radiant electromagnetic wave is converted to a voltage as a result of the electromagnetic induction caused by a change in the electromagnetic wave (more specifically, an electric field and a magnetic field) which passes through the coil.

In this case, it is possible to relatively easily control or optimize the value of the voltage which can be taken out (or converted), depending on various conditions or the like (i.e. indication values for defying the various conditions) which can define the characteristics of the coil, such as the set position of the coil, the material of the core portion, the radius of the coil, the material of the wire material, and the number of turns of the wire material. Thus, it is preferable.

Incidentally, in this aspect, the coil may be disposed in the set position such that an extending direction of the core portion is perpendicular to a radiant direction of the unnecessary radiation.

As described above, if the coil is disposed such that the extending direction of the core portion is perpendicular to the radiant direction of the unnecessary radiant electromagnetic wave, the voltage conversion efficiency of the coil is maximal. This allows the unnecessary radiant electromagnetic wave to be converted to a voltage most efficiently, so it is preferable. Incidentally, the expression that “such that . . . is perpendicular to” does not necessarily mean strict orthogonal nature. The expression includes the state that the coil is disposed so that the directions are perpendicular as much as possible even if there is a spatial limitation, which is due to the shapes of parts which constitute the target equipment and the coil or the like. In other words, this includes a set aspect in which a voltage is generated most efficiently on the coil in one set position in practice.

As explained above, the power regenerating apparatus of the present invention is provided with the converting device and the regenerating device, so that energy resource can be efficiently used.

### BRIEF DESCRIPTION OF THE DRAWINGS

FIG. 1 is a schematic diagram showing a plasma display apparatus in a first embodiment of the present invention;

FIG. 2 is a schematic diagram showing a coil of the plasma display apparatus in FIG. 1;

FIG. 3 is a schematic perspective view showing a display panel device of the plasma display apparatus in FIG. 1;

FIG. 4 is a schematic diagram showing a driving device when the PDP is viewed from the rear panel side;

FIG. 5 is schematic perspective view showing the plasma display apparatus in FIG. 1 viewed from the front panel side of the display panel device;

FIG. 6 is a schematic perspective view showing the plasma display apparatus in FIG. 1 viewed from one side;

FIG. 7 is a schematic diagram showing the display panel device, which is viewed from the front panel side, associated with radiation directions of unnecessary radiant electromagnetic wave on the PDP;

FIG. 8 is a schematic diagram showing the display panel device, which is viewed from one side, associated with radiation directions of unnecessary radiant electromagnetic wave on the PDP;

FIG. 9 is a schematic diagram showing a voltage waveform of the coil in the sustain period of the PDP;

FIG. 10 is a schematic diagram showing a plasma display apparatus in a second embodiment of the present invention; and

FIG. 11 is a schematic diagram showing a plasma display apparatus in a third embodiment of the present invention.

### DETAILED DESCRIPTION OF THE PREFERRED EMBODIMENTS

### 1: First Embodiment

### 1-1: Structure of Embodiment

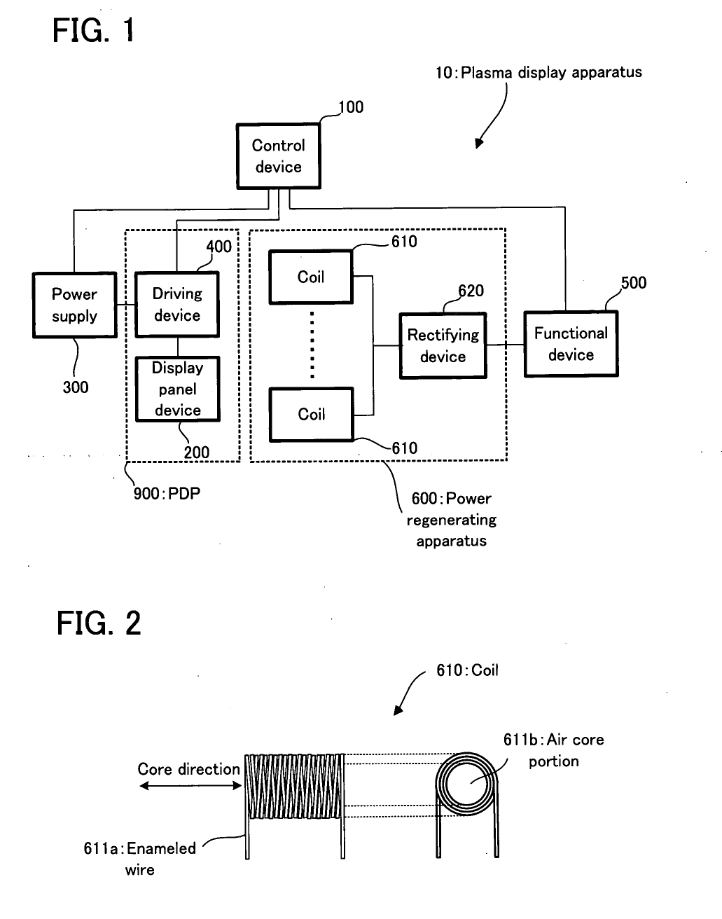

Firstly, with reference to FIG. 1, the structure of a plasma display apparatus 10 in the first embodiment of the present invention will be explained. FIG. 1 is a schematic diagram showing the plasma display apparatus 10.

In FIG. 1, the plasma display apparatus 10 is a displaying apparatus capable of displaying video images corresponding to a video signal to be inputted, and it is one example of the “target equipment” of the present invention. The plasma display apparatus 10 is provided with: a control device 100; a display panel device 200; a power supply 300; a driving device 400; a functional device 500; and a power regenerating apparatus 600. Moreover, the display panel device 200 and the driving device 400 constitute a PDP 900, which is one example of the “plasma display panel” of the present invention.

The control device 100 is an electronic control unit including, e.g., a CPU (Central Processing Unit), ROM (Read Only Memory), RAM (Random Access Memory) or the like. The control device 100 is adapted to control all the operations of the plasma display apparatus 10.

The display panel device 200 is a display panel portion for displaying video images on the plasma display apparatus 10. The display panel device 200 is one example of the display element of the “plasma display panel” of the present invention. Incidentally, the detailed structure of the display panel device 200 will be described later.

The power supply 300 is a power supply unit adapted to supply each device of the plasma display apparatus 10 with a direct current (or DC) voltage as its driving force. The power supply 300 can be connected to a not-illustrated commercial power supply (e.g. alternating current (or AC) 100V power supply). The power supply 300 includes: a known transformer for transforming an AC voltage supplied from the commercial power supply to a voltage according to the operational condition of each device of the plasma display apparatus 10; a known rectifier for converting the transformed AC voltage to a DC voltage; and a known stabilized power supply circuit for stabilizing various DC voltages obtained through the rectifier.

The driving device 400 is a drive unit adapted to supply operating voltages to the various electrodes described later of the display panel device 200. The driving device 400 is mounted on the rear side of the display panel device 200. The driving device 400 includes: a plurality of switching elements; a plurality of DC power supplies connected to the rectification output terminals of the power supply 300; a resistive element; a condenser; and the like. The driving device 400 is electrically connected to the control device 100. Under the control of the control device 100 (e.g. in accordance with driving data supplied from the control device 100), the driving device 400 drives the switching elements in proper timing, to thereby supply the various electrodes described later with various driving pulse voltages. Incidentally, the details of the driving device 400 will be described later.

The functional device 500 is provided with at least one device for performing an auxiliary function, which is different from the main functional operation of the plasma display apparatus 10, i.e. displaying video images on the display panel device 200 of the PDP 900, driving various electrodes on the driving device 400, or performing similar operations. The functional device 500 includes: a cooling fan adapted to cool down the PDP 900; a light receiving device adapted to receive infrared rays related to a command, which is transmitted by a user through a remote control device, such as a remote controller; various indicators, such as a LED (Light Emitting Diode), adapted to visually display the operational state of the PDP 900, e.g. the powered state of a main power supply (simply speaking, an operational state of whether the main power supply is on or in a standby state, or the like).

The power regenerating apparatus 600 is provided with: a plurality of coils 610; and a rectifying device 620. The power regenerating apparatus 600 is one example of the “power regenerating apparatus” of the present invention.

The coil 610 is an air core coil disposed in a set position described later on the PDP 900. The coil is one example of the “converting device” of the present invention. Now, with reference to FIG. 2, the detailed structure of the coil 610 is explained. FIG. 2 is a schematic diagram showing the coil 610.

In FIG. 2, the coil 610 has such a structure that an enameled wire 611a (i.e. one example of the “wire material” of the present invention) is wound on an air core portion 611b (i.e. one example of the “core portion” of the present invention) with dozens of turns, wherein the air core portion 611b extends in an illustrated core direction and a cross section perpendicular to the core direction is formed in an almost circular shape.

In the embodiment, with regard to the physical structure of the coil 610, the number of turns is 70, the cross section of the enameled wire 611a is 0.5 mm, and the diameter of the air core portion 611b is 83 mm. This physical structure of the coil 610 is merely one example, and there is no limitation as long as unnecessary radiant electromagnetic wave described later can be regenerated.

Back in FIG. 1, the rectifying device 620 is provided with: a plurality of diodes; a resistive element; a condenser; and the like. The rectifying device 620 is one example of the “regenerating device” of the present invention, adapted to convert an AC voltage to a DC voltage. The rectifying device 620 is electrically connected to each of the plurality of coils 610. The rectifying device 620 converts an AC voltage generated on the coil 610 to a DC voltage and smoothes DC ripple by leveling by the condenser or the like, to thereby supply a stable DC voltage. Incidentally, on the plasma display apparatus 10, the rectifying device 620 is electrically connected to the above-mentioned functional device 500 by a power supply line, which is another example of the “regenerating device” of the present invention and whose numerical reference is omitted.

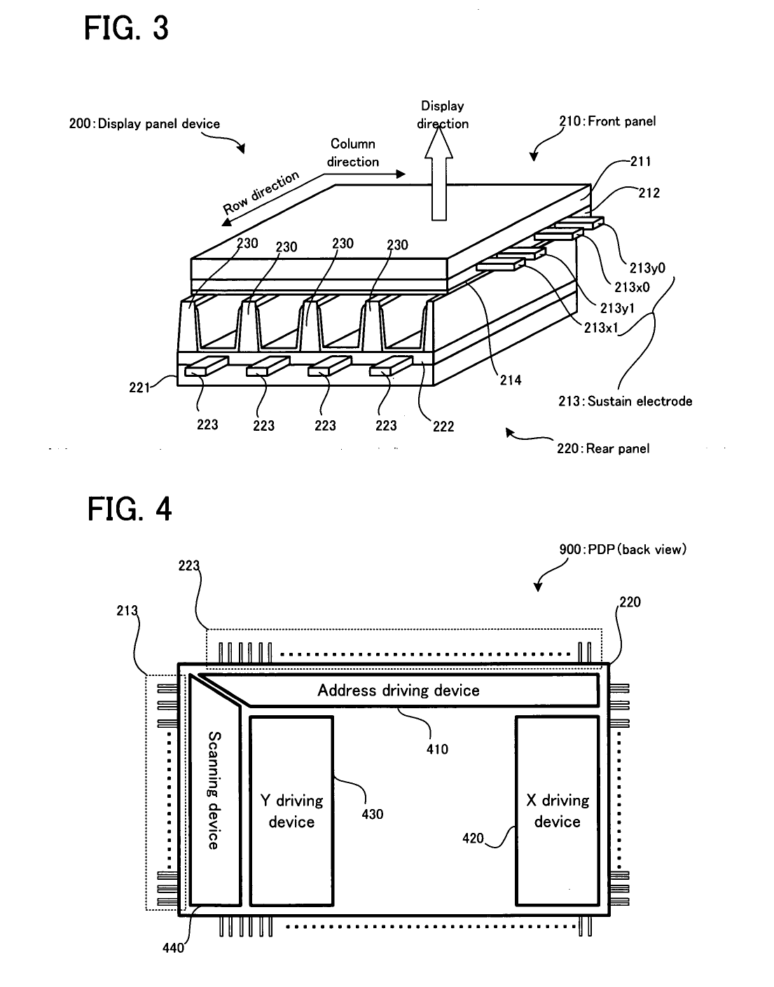

Next, with reference to FIG. 3, the detailed structure of the display panel device 200 will be explained. FIG. 3 is a schematic perspective view showing the display panel device 200.

In FIG. 3, the display panel device 200 is provided with: a front panel 210; a rear panel 220; and bulkheads 230.

The front panel 210 is provided with: a glass substrate 211; a dielectric layer 212; sustain electrodes 213xi (i=0, 1, . . . , N: N is a real number); sustain electrodes 213yi (i=0, 1, . . . , N: N is a real number); and a protective film 214.

The glass substrate 211 is a substrate made of glass and is constructed to be the base material of the front panel 210. The sustain electrodes 213xi are formed of indium tin oxide (ITO). The sustain electrodes 213xi are one example of the “sustain electrode” of the present invention, extending in an illustrated column direction and arranged in parallel in an illustrated row direction. The sustain electrodes 213yi also extend in the illustrated column direction and are arranged in parallel in the illustrated row direction, as in the sustain electrodes 213xi. Here, the sustain electrodes 213xi and the sustain electrodes 213yi are alternately arranged in the row direction. One sustain electrode 213xi and one sustain electrode 213yi, which are adjacent to each other, make a pair. In other words, the sustain electrodes 213 are constructed by arranging a plurality of electrode pairs in the row direction. Incidentally, in the explanation below, the term “sustain electrode(s) 213xi” or “sustain electrode(s) 213yi” is used when individual electrodes which constitute an individual electrode pair are expressed. Moreover, the term of “sustain electrode(s) 213” is merely used when they are collectively expressed.

The dielectric layer 212 is provided to shield the front panel 210 from a direct current and to protect the sustain electrodes 213, physically and electrically. The protective film 214 is made of magnesium oxide and is adapted to protect the front panel 210 physically.

The rear panel 220 is provided with: a glass substrate 221; a dielectric layer 222; and address electrodes 223.

The glass substrate 221 is a substrate made of glass and is the base material of the rear panel 220. The address electrodes 223 are strip-shaped electrodes, extending in the illustrated column direction and arranged at regular intervals in the illustrated row direction. The address electrodes 223 are formed such that thin films are formed in the order of Cr, Cu and Cr on the glass substrate 221 before patterning is performed by photolithography.

The dielectric layer 222 is a thin film which protects the address electrodes 223, physically and electrically, and which shields a discharge space defined by the bulkhead 230 from a direct current. The dielectric layer 222 is made of aluminum oxide, titanium oxide, silicon dioxide, or the like.

The bulkheads 230 are insulating wall-type members, formed between the rear panel 220 and the front panel 210. The bulkhead 230 is formed in a portion corresponding to between the address electrodes 223 adjacent to each other, on the rear panel 220. Therefore, a space defined by the bulkhead 230 is a groove space extending in the row direction, as in the address electrode 223. Incidentally, the groove space encloses noble gas, such as Ne, Xe, and Ar, alone or as a mixture. Moreover, fluorescent films corresponding to respective colors of RGB are formed on the internal surface of the bulkhead 230 and a surface corresponding to the upper side of the dielectric layer 222. The films are arranged in order in the illustrated column direction in each groove space. In the groove space, a portion between one address electrode 223 and one electrode pair of the sustain electrodes 213 defines one cell which is the emission unit of the display panel device 200.

Incidentally, the bulkheads 230 in the embodiment are arranged such that a discharge space of the display panel device includes a space corresponding to the intersection in planar vision of the address electrode 223 and the sustain electrode 213. The arrangement and shape of the bulkheads may be arbitrarily determined as long as preferable discharge is allowed in the discharge space surrounded by the fluorescent film in the sealed space defined by the bulkhead and each substrate. For example, the bulkheads may be formed and arranged in a beehive shape, which is referred to as a meander structure. Alternatively, the bulkheads may have a hanging rack shape in each cell.

Next, with reference to FIG. 4, the structure of the driving device 400 will be explained. FIG. 4 is a schematic diagram showing the driving device 400 when the PDP 900 is viewed from the rear panel 220 side. Incidentally, in FIG. 4, the same points as those in FIG. 3 carry the same numerical references and the explanation thereof will be omitted.

In FIG. 4, the driving device 400 is provided with: an address driving device 410; an X driving device 420; a Y driving device 430; and a scanning device 440.

The address driving device 410 is provided with: an address resonance power supply circuit (not illustrated) equipped with a DC power supply, a diode, a coil, a condenser, and the like; and an address driver (not illustrated) equipped with a plurality of switching elements for electrically connecting to each of the address electrodes 223. The address driving device 410 can drive the address electrodes 223. The address driving device 410 is electrically connected to the control device 100, and its operational state is controlled by the control device 100. Incidentally, the detailed circuit configuration of the address driving device 410 may employ the same various aspects as those of a circuit corresponding to the driving device of a known PDP, and the illustration thereof will be omitted here to avoid a complicated explanation.

The X driving device 420 is provided with: a sustain driver (not illustrated) for applying sustain pulse voltages to the sustain electrodes 213xi; and a reset pulse generation circuit (not illustrated) for generating a reset pulse. The X driving device 420 can drive the sustain electrodes 213xi. The X driving device 420 is electrically connected to the control device 100, and its operational state is controlled by the control device 100. Incidentally, the sustain driver is provided with a DC power supply, a switching element, a diode, a condenser, a coil, and the like. Moreover, the reset pulse generation circuit is provided with a DC power supply, a switching element, a resistive element, a condenser, and the like. Incidentally, the detailed circuit configuration of the X driving device 420 may employ the same various aspects as those of a circuit corresponding to the driving device of a known PDP, and the illustration thereof will be omitted here to avoid a complicated explanation.

The Y driving device 430 is provided with: a sustain driver (not illustrated) for applying sustain pulse voltages to the sustain electrodes 213yi; and a reset pulse generation circuit (not illustrated) for generating a reset pulse. The Y driving device 430 can drive the sustain electrodes 213yi. The Y driving device 430 is electrically connected to the control device 100, and its operational state is controlled by the control device 100. Incidentally, the sustain driver is provided with a DC power supply, a switching element, a diode, a condenser, a coil, and the like. Moreover, the reset pulse generation circuit is provided with a DC power supply, a switching element, a resistive element, a condenser, and the like. Incidentally, the detailed circuit configuration of the Y driving device 430 may employ the same various aspects as those of a circuit corresponding to the driving device of a known PDP, and the illustration thereof will be omitted here to avoid a complicated explanation.

The scanning device 440 is a circuit for applying scanning pulse voltages to the sustain electrodes 213yi. The scanning device 440 is provided with a DC power supply, a diode, a switching element, a condenser, a resistive element, and the like. Incidentally, the detailed circuit configuration of the scanning device 440 may employ the same various aspects as those of a circuit corresponding to the driving device of a known PDP, and the illustration thereof will be omitted here to avoid a complicated explanation.

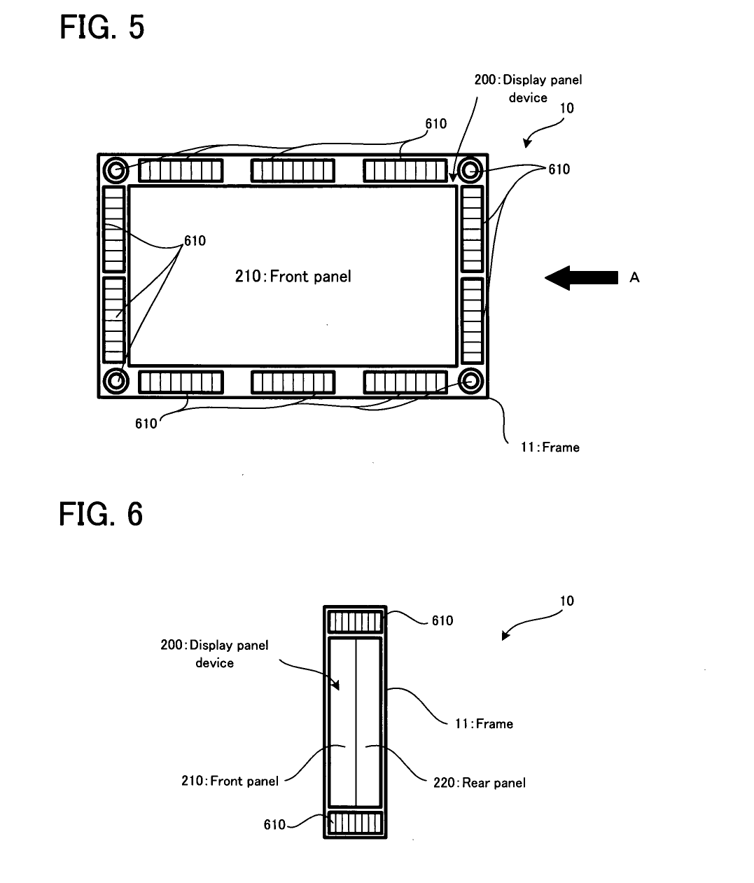

Next, with reference to FIG. 5 and FIG. 6, an aspect of setting the coils 610 will be explained. FIG. 5 is schematic perspective view showing the plasma display apparatus 10 viewed from the front panel 210 side of the display panel device 200. FIG. 6 is a schematic perspective view showing the plasma display apparatus 10 viewed from one side in an arrow A direction of FIG. 5. Incidentally, in each drawing, the same points as those in FIG. 3 carry the same numerical references and the explanation thereof will be omitted.

In FIG. 5, the display panel device 200 is contained in a frame 11 (not illustrated in FIG. 3) of the plasma display apparatus 10. The plurality of coils 610 are arranged along the display panel device 200 within the frame 11 and in the external space of the display panel device 200. Moreover, in the positions corresponding to the four corners of the display panel device 200, as illustrated in detail in FIG. 6, the coils 610 are arranged such that the depth direction of the display panel device 200 (i.e. the direction perpendicular to the sheet of paper in FIG. 5) matches the extending direction of the air core portion 611b.

### 1-2: Operation of Embodiment

### 1-2-1: Operation of PDP 900

Next, with reference to FIG. 1, FIG. 3, and FIG. 4, the emission operation of the PDP 900 will be explained. In the embodiment, the emission operation of the PDP 900 is controlled by the control device 100. The emission operation is realized by repeatedly performing a cycle wherein one cycle is provided generally with the following four types of operation periods, resulting in the display of a predetermined video image in the display direction in FIG. 3.

### 1-2-1-1: Reset Period

In a reset period, the control device 100 controls a reset switch on the above-mentioned reset pulse generation circuit of the X driving device 420 so as to apply negative reset pulse voltages to the sustain electrodes 213xi (i.e. makes the switch related to the resetting ON for a predetermined time length). Moreover, the control device 100 controls a reset switch on the above-mentioned reset pulse generation circuit of the Y driving device 430 so as to apply negative reset pulse voltages to the sustain electrodes 213yi (i.e. makes the switch related to the resetting ON for a predetermined time length). The application of the reset pulse voltages to the sustain electrodes 213 causes discharge in all the cells, generating charged particles and forming wall charges in each cell.

On the other hand, if the switch related to the resetting is made OFF on each of the X driving device 420 and the Y driving device 430, the control device 100 controls the sustain driver of each driving device to fix each potential of the sustain electrodes 213xi and the sustain electrodes 213yi to an earth potential. At this time, all the cells of the display panel device 200 are set to emission cells (i.e. the cells with wall charged formed), and the reset period ends.

### 1-2-1-2: Address Period

In an address period, the control device 100 controls the scanning device 440 so as to apply scanning pulse voltages sequentially to the sustain electrodes 213yi. The scanning pulse voltage has a predetermined negative potential and positive potential as peaks. On the other hand, the control device 100 controls the resonance power supply circuit and the address driver of the address driving device 410 so as to apply data pulse voltages to the address electrodes 223 corresponding to non-emission cells (i.e. cells which do not allow emission) in such timing that the potentials of the sustain electrodes 213yi are the peak on the negative potential side. For example, the control device 100 changes the switching state of the address driver so as to select the address electrodes sequentially in the period that the data pulse voltage is outputted from the resonance power supply circuit. The cell is set to the non-emission cell, wherein the wall charges formed in the reset period are eliminated in the cell to which the data pulse voltage is applied in synchronization with the scanning pulse voltage in this manner. The address period ends when all the cells of the display panel device 200 are set to the emission cells (i.e. the cells with the wall charges remaining) or the non-emission cells.

### 1-2-1-3: Sustain Period

In a sustain period, the control device 100 controls the sustain driver of the X driving device 420 so as to apply sustain pulse voltages of approximately 200V to the sustain electrodes 213xi. Moreover, when ending the application of the sustain pulse voltages to the sustain electrodes 213xi, the control device 100 controls the sustain driver of the Y driving device 430 so as to apply similar sustain pulse voltages to the sustain electrodes 213yi. In the sustain period, the application of the sustain pulse voltages to the sustain electrodes 213xi and 213yi in this manner is repeated, and discharge is repeated in the cell set to the emission cell in the previous address period.

The discharge in the sustain period generates light in the ultraviolet region with wavelengths of nearly 143 nm and 172 nm in each emission cell, exciting each fluorescent film formed in the discharge space to thereby generate light in the visible region (hereinafter referred to as “visible light”, as occasion demands). The visible light generated in this manner is visible in the exterior (mainly, in a direction according to the display direction in FIG. 3).

### 1-2-1-4: Elimination Period

When the sustain period ends, the control device 100 controls the Y driving device 430 so as to apply elimination pulse voltages to the sustain electrodes 213yi. The elimination pulse voltage eliminates the wall charges in all the cells.

### 1-2-2: Unnecessary Radiation of Electromagnetic Wave

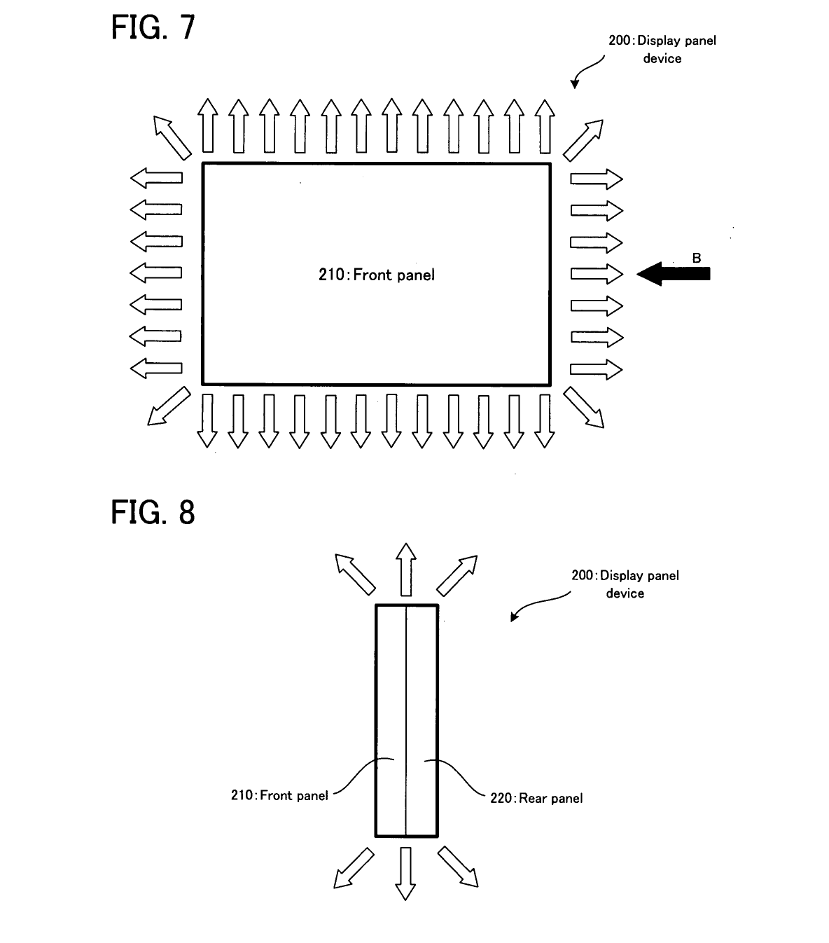

Meanwhile, along with the emission operation of the PDP 900 described above, the unnecessary radiation of electromagnetic wave is generated mainly on the display panel device 200, the driving device 400, or the like. Now, with reference to FIG. 7 and FIG. 8, the radiant direction of the unnecessary radiation will be explained. FIG. 7 is a schematic diagram showing the display panel device 200, which is viewed from the front panel 210 side. FIG. 8 is a schematic diagram showing the display panel device 200, which is viewed from one side in a black arrow B direction in FIG. 7. Incidentally, in the drawings, the same points as those in FIG. 5 and FIG. 6 carry the same numerical references and the explanation thereof will be omitted.

In FIG. 7, if the display panel device 200 is viewed from the front panel 210 side, the unnecessary radiation of the electromagnetic wave on the plasma display panel apparatus 10 is generated generally in outline arrow directions. In other words, the unnecessary radiant electromagnetic wave radiates into the outer circumference of the display panel device 200. Moreover, if the display panel device 200 is viewed from the side, the unnecessary radiant electromagnetic wave radiates from the upper and lower edge portions, as shown in outline arrow directions in FIG. 8.

### 1-2-3: Operation of Power Regenerating Apparatus 600

The above-mentioned unnecessary radiant electromagnetic wave is normally shielded by a not-illustrated shield member or the like and does not leak to the exterior of the frame 11. However, just the shielding in this manner is equal to discarding the unnecessary radiant electromagnetic wave, which can be used as energy resource, resulting in low use efficiency of energy. Thus, in the embodiment, the unnecessary radiant electromagnetic wave is regenerated by the power regenerating apparatus 600. Now, with reference to FIG. 1, the operation of the power regenerating apparatus 600 will be explained.

In the operation of the power regenerating apparatus 600, firstly, the unnecessary radiant electromagnetic wave is converted to an AC voltage by the coil 610 having the above-mentioned set aspect. That is, electromotive force is induced on the coils by a time change in an electromagnetic field due to the unnecessary radiation of the electromagnetic wave.

On the other hand, the AC voltage generated on each coil 610 is outputted to the rectifying device 620. On the rectifying device 620, the AC voltage is converted to a DC voltage and the DC ripple is smoothed to generate a stable DC voltage. The DC voltage outputted through the rectifying device 620 is supplied to the functional device 500, which is electrically connected to the rectifying device 620 through the power supply. line. Since each is an electrical load, an electric current is generated in the power supply line, which drives the functional device 500.

As described above, on the plasma display apparatus 10 in the embodiment, one portion of the unnecessary radiant electromagnetic wave generated by the operation of the plasma display apparatus 10 is eventually regenerated as a DC power which drives the functional device 500. That is, it is possible to efficiently use energy resource.

Now, with reference to FIG. 9, the characteristics of the unnecessary radiant electromagnetic wave will be explained. FIG. 9 is a schematic diagram showing an AC voltage waveform converted by the coil 610 in the above-mentioned sustain period of the PDP 900. Incidentally, the voltage waveform illustrated in FIG. 9 corresponds to a waveform measured by predetermined measurement equipment (e.g. an oscilloscope or the like), with a load resistance of 50Ω, to clearly show the voltage waveform.

In FIG. 9, a vertical axis represents voltage, a horizontal axis represents time, and the waveform of voltage generated on the coil 610 is represented as PrfV. As can be clearly seen from PrfV, a burst-like voltage is generated on the coil 610, wherein the voltage corresponds to a peak difference of approximately 2Vp and the peak difference is defined from a negative peak voltage “−Vp” and a positive peak voltage “+Vp” in each illustrated cycle ΔT, in synchronization with the timing that the sustain pulse voltage is applied to each of the sustain electrodes 213xi and the sustain electrodes 213yi in the above-mentioned sustain period.

As described above, on the plasma display apparatus 10, the voltage is generated on the 610 in the operation period of the PDP 900, more specifically in the sustain period; however, the voltage waveform shown in FIG. 9 is merely exemplification. The peak value of the voltage generated on the coil 610 varies depending on the set position of the coil 610. In particular, this time, it is experimentally confirmed that the voltage is the highest in the positions corresponding to the sustain drivers of the X driving device 420 and the Y driving device 430 of the driving device 400, for example, near the four corners of the display panel device 200 when the display panel device 200 is viewed from the display panel 210 side.

In particular, on the plasma display apparatus 10 in the embodiment, the coils 610 are disposed even in the positions corresponding to the four corners, as shown in FIG. 5 and FIG. 6 (i.e. the set position of the coil 610 is one example of the “position corresponding to the sustain electrode” of the present invention). This allows the unnecessary radiant electromagnetic wave to be captured, efficiently and effectively.

Moreover, as a general characteristic of the coil 610, the electromagnetic wave is converted to the voltage most efficiently if the radiant direction of the electromagnetic wave is perpendicular to the core direction of the coil 610 (refer to FIG. 2). This point is also considered on the plasma display apparatus 10 in the embodiment. As is clear from the comparison of FIG. 5 and FIG. 6, and that of FIG. 7 and FIG. 8, the coils 610 are arranged such that the core direction of the coil 610 is perpendicular to the radiant direction of the unnecessary radiant electromagnetic wave. Therefore, the power regenerating apparatus 600 of the plasma display apparatus 10 can generate an AC voltage extremely efficiently and effectively, in combination with the set position of the coil described above.

Moreover, the functional device 500 in the embodiment includes a cooling fun. In view of the effect of the cooling fun, it is obvious that the extent of cooling needs to be further increased if the PDP 900 has a higher temperature. The heating of the PDP 900 is mainly due to plasma discharge in each cell. In this case, as the brightness is higher, the sustain drivers of the X driving device 420 and the Y driving device 430 are driven more frequently in the sustain period described above. Thus, the PDP 900 generates heat more easily.

On the other hand, the unnecessary radiation of the electromagnetic wave is generated significantly in response to the driving of each sustain driver as described above (e.g. the application of the sustain pulse voltages to the sustain electrodes 213). Therefore, the voltage converted through the coils 610 is also increased depending on the driving frequency of the sustain driver. Therefore, on the plasma display apparatus 10, electric energy regenerated by the power regenerating apparatus 600 also increases if the cooling fun needs to be driven under a higher load condition. That is, according to the power regenerating apparatus 600, it is not necessary to control it to change the load of the cooling fun depending on the operational condition of the PDP 900, and it is possible to increase the load of the cooling fun with increasing the calorific value of the PDP 900, namely, automatically. Thus, it is extremely useful in practice.

### 2: Second Embodiment

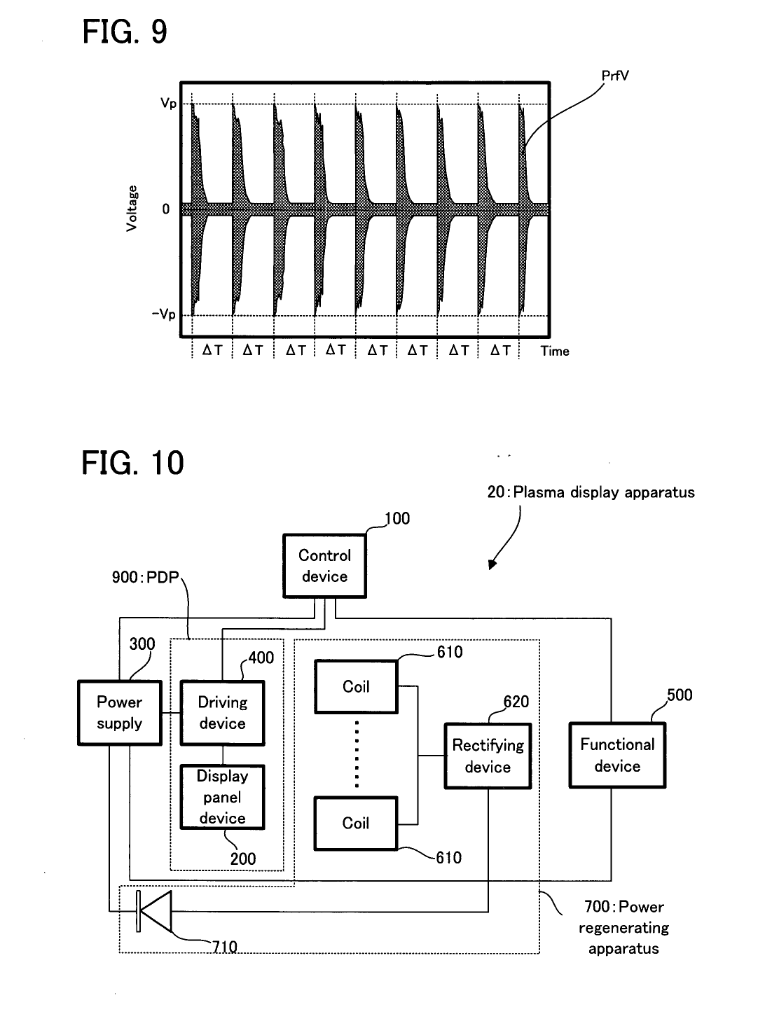

The power regenerating apparatus can employ various aspects without being limited to the first embodiment. Now, with reference to FIG. 10, the second embodiment of the present invention will be explained. FIG. 10 is a schematic diagram showing a plasma display apparatus 20 in the second embodiment of the present invention. Incidentally, in FIG. 10, the same positions as those in FIG. 1 carry the same numerical references and the explanation thereof will be omitted.

In FIG. 10, the plasma display apparatus 20 differs from the plasma display apparatus 10 in the first embodiment in that it has a power regenerating apparatus 700 instead of the power regenerating apparatus 600.

The power regenerating apparatus 700 differ noticeably from the power regenerating apparatus 600 in that the rectification output terminal of the rectifying device 620 is electrically connected to the rectification output terminal of the power supply 300 through a back-flow prevention diode 710. Incidentally, with this change in the structure, the driving voltage of the functional device 500 is supplied from the power supply 300, which is electrically connected to the functional device 500. Moreover, the back-flow prevention diode 710 is a diode provided to prevent an electric current from buck-flowing even if the voltage of the power supply 300 is higher than the output voltage of the rectifying device 620.

On the power regenerating apparatus 700, basically, the voltage related to the unnecessary radiant electromagnetic wave is regenerated for the power supply 300 only if the voltage at the rectification output terminal of the rectifying device 620 is higher than the output voltage of the power supply 300. At this time, even the low voltage obtained through the coil 610 enables the functional device 500 to be operated more stably, so it is preferable.

Incidentally, in the embodiment, if the output voltage of the rectifying device 620 needs to be further increased, a known n-time voltage rectifying circuit (wherein n is an integer of 2 or more) may be provided between the rectifying device 620 and the power supply 300, or by being united with the rectifying device 620.

### 3: Third Embodiment

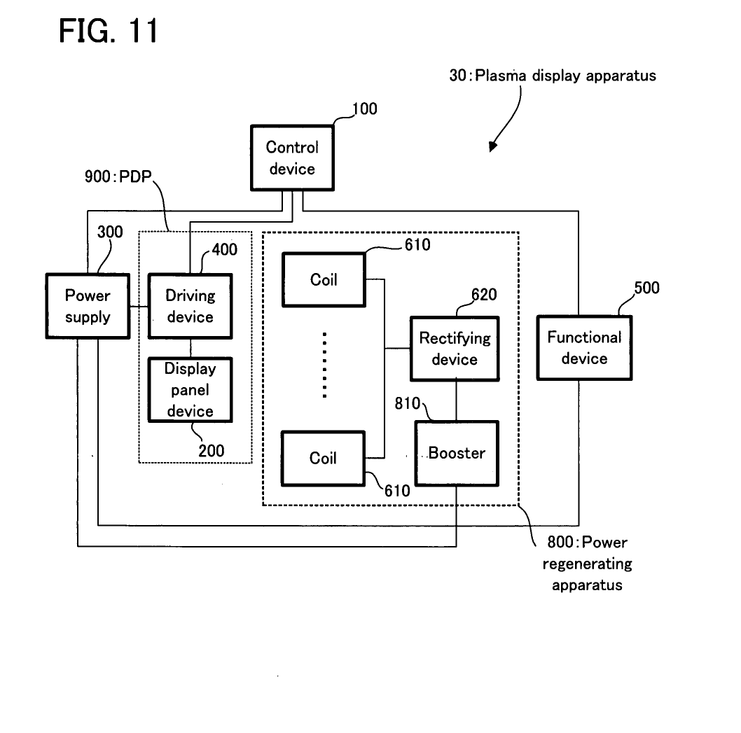

The power regenerating apparatus can also employ another embodiment. Now, with reference to FIG. 11, the third embodiment of the present invention will be explained. FIG. 11 is a schematic diagram showing a plasma display apparatus 30 in the third embodiment of the present invention. Incidentally, in FIG. 11, the same positions as those in FIG. 1 carry the same numerical references and the explanation thereof will be omitted.

In FIG. 11, the plasma display apparatus 30 differs from the plasma display apparatus 10 in the first embodiment in that it has a power regenerating apparatus 800 instead of the power regenerating apparatus 600.

The power regenerating apparatus 800 differ noticeably from the power regenerating apparatus 600 in that it is provided with a booster 810 and that, as in the second embodiment described above, the rectification output terminal of the rectifying device 620 is electrically connected to the rectification output terminal of the power supply 300 through a back-flow prevention diode 710. Incidentally, with this change in the structure, the driving voltage of the functional device 500 is supplied from the power supply 300, which is electrically connected to the functional device 500, as in the second embodiment.

The booster 810 includes a DC-DC converter or the like and is adapted to boost the output voltage of the rectifying device 620. In this case, the boosting characteristic of the booster 810 is provided such that the output voltage of the booster 810 is higher than the output voltage of the power supply 300. Therefore, in the third embodiment, even if the voltage converted on the coils 610 is small, some DC power is regenerated for the power supply 300, so it is useful in practice.

Incidentally, the booster 810 may be provided with a plurality of switching elements to maintain the output voltage of the booster 810 higher than the output voltage of the power supply 300 all the time. In this case, for example, the switching state of the switching elements may be changed under the control of the control device 100 to maintain the above-mentioned voltage relationship.

Incidentally, even the power regenerating apparatus 800 may be provided with the back-flow prevention diode, as in the above-mentioned second embodiment. In this case, the boosting characteristic of the booster 810 may be provided such that the output voltage of the booster 810 is higher than a voltage obtained by further adding a forward voltage of the back-flow prevention diode to the output voltage of the power supply 300.

Incidentally, in the embodiment, the booster 810 may be unified with the rectifying device 620 or may be separated from it.

Incidentally, in the above-mentioned various embodiments, the AC voltage converted through the coils 610 is converted to a DC voltage by the rectifying device 620 and it is eventually regenerated for the plasma display apparatus as a DC current through a not-illustrated power supply line. If, however, the plasma display apparatus has an AC driving device, such as a three-phase motor, in one portion of the functional device 500 or completely independently, the AC voltage converted on the coils 610 may be supplied to the AC driving device, directly as AC power through the power supply line without the rectifying device 620, or indirectly through an inverter, if necessary, which is located on the power supply line and which is adapted to convert the frequency and the voltage under the control of the control device 100. That is, the regeneration of the unnecessary radiant magnetic wave in the present invention can employ various forms, regardless of the difference of DC and AC.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A power regenerating apparatus comprising:
a converting device, which is disposed in a set position in which said converting device is in contact with electromagnetic wave related to unnecessary radiation of target equipment with the unnecessary radiation of the electromagnetic wave in operation and which converts the electromagnetic wave related to the unnecessary radiation to a voltage corresponding to the electromagnetic wave related to the unnecessary radiation; and
a regenerating device for regenerating electric power corresponding to the converted voltage for at least one portion of the target equipment corresponding.

2. The power regenerating apparatus according to claim 1, wherein the target equipment includes a plasma display panel.

3. The power regenerating apparatus according to claim 2, wherein the set position includes a position corresponding to a sustain electrode of the plasma display panel.

4. The power regenerating apparatus according to claim 1, wherein said converting device includes a coil in which a conductive wire material is wound on a core portion.

5. The power regenerating apparatus according to claim 4, wherein the coil is disposed in the set position such that an extending direction of the core portion is perpendicular to a radiant direction of the unnecessary radiation.
